(19) United States
(12) Patent Application Publication
(10) Pub. No.: US 2024/0377786 A1
(43) Pub. Date: Nov. 14, 2024

(54) SWITCHING DEVICE, ELECTRONIC DEVICE, AND TIMEPIECE

(71) Applicant: CASIO COMPUTER CO., LTD., Tokyo (JP)

(72) Inventors: Chieko TAJIMA, Tokyo (JP); Shoma MORI, Tokyo (JP)

(73) Assignee: CASIO COMPUTER CO., LTD., Tokyo (JP)

(21) Appl. No.: 18/661,016

(22) Filed: May 10, 2024

(30) Foreign Application Priority Data
May 10, 2023 (JP) 2023-077537

(51) Int. Cl. G04B 3/04; G04G 17/08

(52) U.S. Cl. CPC G04B 3/041; G04G 17/08

(57) ABSTRACT

Disclosed is a switching device including: an enclosure that is provided on an outer part of a case and opens toward an outside of the case; a filter arranged in the enclosure; an operation receiver that is arranged on an outer side of the case relative to the filter and includes: a shaft having one end side inserted in an insertion hole provided to extend through from the enclosure toward an inside of the case; and an operation head provided on the other end side of the shaft and arranged at least partially in the enclosure; and a rotation restrictor that restricts rotation of the operation receiver.

### REFERENCE TO RELATED APPLICATIONS

This application is based upon and claims the benefit of priority from the prior Japanese Patent Application No. 2023-077537, filed on May 10, 2023, the entire contents of which are incorporated herein by reference.

### TECHNICAL FIELD

The present disclosure relates to a switching device, an electronic device, and a timepiece.

### DESCRIPTION OF RELATED ART

JP 6465327B describes a timepiece including a switching device that includes a cylindrical member protruding to the outside of a case and a winder inserted rotatably through the cylindrical member, in which protrusions and recesses are formed on a circumferential surface of either of the cylindrical member and the winder, and engagement portions engaged with the protrusions and recesses are formed on a circumferential surface of the other one of the cylindrical member and the winder.

### SUMMARY OF THE INVENTION

To solve the above-described problems, a switching device according to the present disclosure is a switching device including: an enclosure that is provided on an outer part of a case and opens toward an outside of the case; a filter arranged in the enclosure; an operation receiver that is arranged on an outer side of the case relative to the filter and includes: a shaft having one end side inserted in an insertion hole provided to extend through from the enclosure toward an inside of the case; and an operation head provided on the other end side of the shaft and arranged at least partially in the enclosure; and a rotation restrictor that restricts rotation of the operation receiver.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a plan view of a timepiece in an embodiment;

FIG. 2 is a main part cross-sectional view of the timepiece on the six o'clock side illustrating a state in which the timepiece is cut along the line II-II in FIG. 1;

FIG. 3 is a main part enlarged perspective view illustrating a state in which a switching device and a band have been detached from the six o'clock side of a case of the timepiece;

FIG. 4 is an exploded perspective view of the switching device in the present embodiment;

FIG. 5 is a side view illustrating the switching device illustrated in FIG. 4 in an exploded state;

FIG. 6 is a main part enlarged perspective view of the six o'clock side of the timepiece in FIG. 1; and

FIG. 7A is an example of a cross-sectional view of a shaft as a rotation restrictor, FIG. 7B is another example of the cross-sectional shaft as the rotation restrictor, and FIG. 7C is still another example of the cross-sectional view of the shaft as the rotation restrictor.

### DETAILED DESCRIPTION

### Configuration

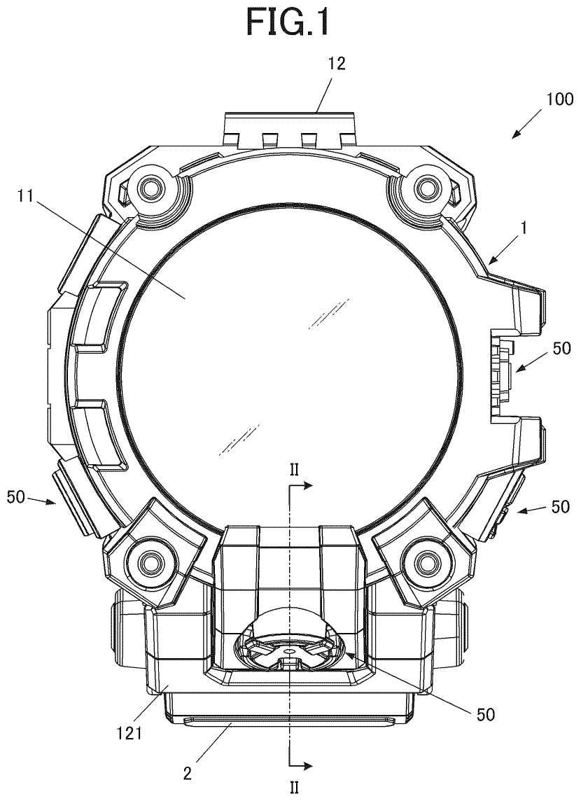

An embodiment of a switching device and an electronic device including the switching device according to the present disclosure will be described with reference to FIG. 1 to FIG. 6.

Note that the following embodiment will be described taking, as an example, a case in which an electronic device provided with a switching device 50 is a wristwatch-type timepiece (hereinafter referred to as a “timepiece 100”), for example. Technically preferable various limitations for carrying out the present disclosure, which are imposed on the following embodiment, are not intended to limit the scope of the present disclosure to the following embodiment and illustrated examples. Note that hereinafter, an upper side shall be a front side (a visible side) of the timepiece 100, and a lower side shall be a back side (an invisible side) of the timepiece 100.

There has been conventionally a switching device that includes a cylindrical member protruding to the outside of a case and a winder inserted rotatably through the cylindrical member, in which protrusions and recesses are formed on a circumferential surface of either of the cylindrical member and the winder, and engagement portions engaged with the protrusions and recesses are formed on a circumferential surface of the other one of the cylindrical member and the winder.

Such a switching device can prevent free rotation of the operation receiver.

However, such a switching device cannot eliminate the gap created in the portion where the operation head is exposed to the outside of the case even by locking the operation receiver so as not to rotate. It is therefore impossible to prevent entry of dirt, dust, and the like, which is a problem.

The present invention has been made to improve and solve the problem of such situations and enables preventing improper rotation of the operation receiver and prevent foreign matters such as dirt from entering the inside.

FIG. 1 is a front view of the timepiece in the present embodiment.

As illustrated in FIG. 1, the timepiece 100 of the present embodiment includes a case 1.

The case 1 is formed of a metal material such as titanium or stainless steel (SUS), for example. The material that forms the case 1 is not limited to those illustrated herein. For example, the case 1 may be formed of any type of ceramic or the like. The case 1 may be formed of a rigid material such as a rigid synthetic resin including a super engineering plastic such as polyarylate (PAR), an engineering plastic such as polyacetal (POM), and the like. A composite material such as a carbon fiber reinforced resin may be adopted.

The case 1 of the present embodiment is formed in a hollow short-columnar shape with the top and bottom open.

The upper side (the front side; the visible side of the timepiece 100) of the case 1 is closed by a windshield member 11. The windshield member 11 is a transparent member formed of glass, resin, or the like, for example.

The open portion on the back surface side (the invisible side of the timepiece 100) of the case 1 is closed by a back cover member not illustrated. Note that the back cover member may be formed integrally with the case 1.

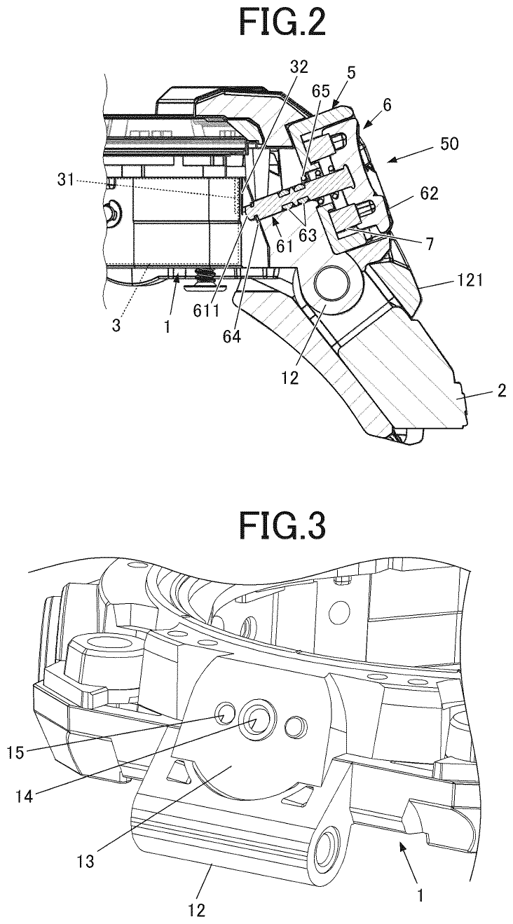

As illustrated in FIG. 1, band attachments 12 for respectively coupling bands 2 (see FIG. 2) to the case 1 are provided on the outer part of the case 1 at positions corresponding to the six o'clock side and the twelve o'clock side of an analog timepiece.

In the present embodiment, an exterior member 121 is attached to the outside of the case 1 so as to cover the band attachment 12 and part of an attached side of the band 2 attached to the band attachment 12. Note that it is not indispensable to provide the exterior member 121.

A hollow portion in the case 1 constitutes an enclosure space that encloses various components. In the present embodiment, a timepiece module (hereinafter briefly referred to as a “module 3”) illustrated in FIG. 2 is enclosed in the case 1.

The module 3 is obtained by incorporating a substrate, various components, and the like into a housing formed of any type of resin or the like in a substantially cylindrical shape, for example. Note that the details are not illustrated.

Although illustration is omitted, a display unit including a liquid crystal panel and the like, a hand shaft as a hand-type display, and the like, for example, are provided on the front surface side of the module 3 (the upper side in FIG. 2; the side to be the visible side when incorporating the module 3 into the case 1 of the timepiece 100), for example. Various hands are attached to the hand shaft. In the case where the timepiece 100 has hands, then a motor, a gear train mechanism, and the like (neither illustrated) that operate the hands are incorporated into the module 3 as appropriate.

Note that the timepiece 100 may be a hybrid timepiece including the display unit and the hand shaft and having both an analog display and a digital display, or may be one that only includes a display unit without having hands or the like, for example, to digitally display the time and the like, or may be an analog timepiece including hands and a dial face without having any display unit.

The substrate is a plate-like member as LSI (Large-Scale Integration), for example, and has mounted thereon various electronic components for performing various operations of the timepiece 100. The substrate also has an electronic circuit (including electrodes) connecting these electronic components, and the like. Examples of the electronic components may include a microcomputer, an external storage (such as a flash memory), a large-capacity capacitor, timepiece operation units for various functional operations such as communication and measurement, a quartz oscillator, and the like. For example, the microcomputer counts the time (which may include date information) utilizing a clock signal in response to oscillation of the quartz oscillator. In the case where the timepiece 100 includes a display unit, the microcomputer causes a display screen of the display unit to display the time and the like.

The switching devices 50 are provided on a lateral part of the timepiece 100. The provided positions and number of the switching devices 50 are not particularly limited. In the present embodiment, for example, the switching devices 50 are arranged on the three o'clock side, the four o'clock side, the six o'clock side, and the eight o'clock side of the analog timepiece as illustrated in FIG. 1. The switching device 50 is a push-button switch for switching by a pressing operation, for example.

Note that at least one of the switching devices 50 (in the embodiment, the switching device 50 arranged on the six o'clock side) should only have the configuration illustrated in FIG. 3 to FIG. 5, and the switching devices 50 arranged at the other positions may have a different configuration. Alternatively, all of the switching devices 50 provided for the timepiece 100 may have a configuration similar to the configuration of the switching device 50 on the six o'clock side.

FIG. 2 is a main part cross-sectional view of the timepiece on the six o'clock side illustrating a state in which the timepiece is cut along the line II-II in FIG. 1.

Switching electrodes 31 are provided as appropriate on the front and side surfaces of the substrate at positions corresponding to the switching devices 50 as illustrated in FIG. 2. A switching plate spring 32 that can be electrically connected to the switching electrode 31 is arranged at a position that can be pressed by a shaft 61 of a operation receiver 6 of the switching device 50.

The switching plate spring 32 is to detect a pressing operation on the operation receiver 6 of the switching device 50 (a pushing operation of pushing an operation head 62 which will be described later). The switching plate spring 32 is arranged at least partially at a position with which a leading end 611 of the operation receiver 6 can make contact when the operation receiver 6 is pressed (pushed). Note that in a state where the operation receiver 6 is not pushed, the leading end 611 of the operation receiver 6 may or may not make contact with the switching plate spring 32.

Note that the switching plate spring 32 may be electrically connected to the switching electrode 31 through direct contact, or may be electrically connected to the switching electrode 31 through indirect contact via a terminal plate or the like.

In the present embodiment, the switching device 50 (for example, the switching device 50 arranged on the six o'clock side of the timepiece 100 illustrated in FIG. 1 and the like) includes an enclosure, the operation receiver 6, and a filter 7.

The enclosure is a portion that is provided on the outer part of the case 1 and is open to the outer side of the case 1, and has an insertion hole provided to extend through from a surface on the farther side of the enclosure toward the inside of the case 1. In the present embodiment, the enclosure is implemented by a protector 5 attached to the outer part of the case 1.

Note that in the present embodiment, the protector 5 is a member separate from the case 1, but does not need to be a separate member. The case 1 and the protector 5 may be structured integrally.

FIG. 3 is a main part perspective view of the case of the timepiece on the six o'clock side and illustrates a state in which the switching device has been detached from the case.

As illustrated in FIG. 3, in the present embodiment, a protector mount 13 for attaching the protector 5 is provided on the side surface of the case 1 at the position where the switching device 50 is provided.

The switching device 50 arranged on the six o'clock side of the timepiece 100 in the present embodiment has a configuration in which a pushing operation is performed from obliquely above, and the protector mount 13 has an inclined surface directed obliquely upward.

A first insertion hole 14 extending through the case 1 from the inside to the outside is formed in a substantially central part of the protector mount 13. A screw hole 15 is formed in the vicinity of the first insertion hole 14. Because of the waterproof structure, the screw hole 15 does not extend through the case 1 to the inside. In other words, if the screw hole 15 extends through, a problem arises in that water enters through the screw hole 15.

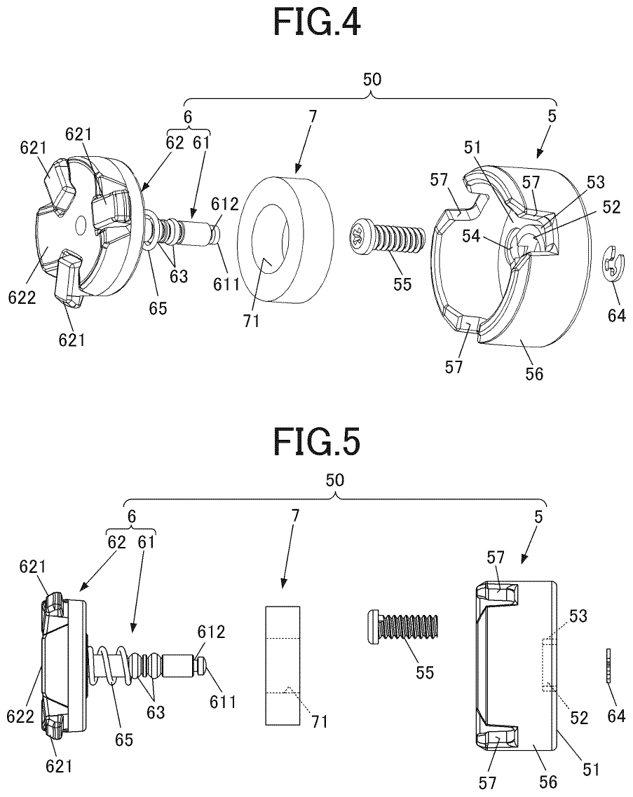

FIG. 4 is an exploded perspective view of the switching device (for example, the switching device arranged on the six o'clock side) in the present embodiment, and FIG. 5 is a side view illustrating the switching device illustrated in FIG. 4 in an exploded state.

As illustrated in FIG. 4 and FIG. 5, the protector 5 has a fixed-side surface 51 and a cylindrical side surface portion 56 provided to stand from the periphery of the fixed-side surface 51, and an unfixed side is open. In the present embodiment, the fixed-side surface 51 is formed in a substantially disc-like shape, and the protector 5 is a substantially cylindrical member as a whole. The protector 5 is formed of metal such as SUS, for example, but the material that forms the protector 5 is not limited to metal.

The “fixed-side surface 51” of the protector 5 is fixed to the case 1 (in the present embodiment, the protector mount 13 of the case 1) and constitutes the “surface on the farther side” of the enclosure.

In a substantially central part of the fixed-side surface 51, a small-diameter cylindrical portion 53 which is a cylindrical portion formed concentrically with the cylindrical side surface portion 56 is provided to stand on the inner side of the side surface portion 56.

At substantially the center of the small-diameter cylindrical portion 53, a second insertion hole 52 corresponding to the first insertion hole 14 on the case 1 side is formed. In the present embodiment, the first insertion hole 14 on the case 1 side and the second insertion hole 52 on the protector 5 side constitute the insertion hole extending through the case 1 from the inside to the outside.

The fixed-side surface 51 also has a screw hole 54 which is a through-hole formed at a position corresponding to the screw hole 15 of the protector mount 13 in the case 1. In the present embodiment, a screw 55 is inserted from the screw hole 54 to the screw hole 15. When the screw 55 inserted through the screw hole 54 which is the through-hole is screwed with the screw hole 15, the protector 5 is fixed to the protector mount 13.

Note that although FIG. 3 to FIG. 5 illustrate the example in which the protector 5 is fixed to the protector mount 13 with the single screw 55, the configuration in which the protector 5 is fixed to the protector mount 13 is not limited to this. For example, the screw hole 15 and the corresponding screw hole 54 may be provided at a plurality of positions so that the protector 5 may be fixed to the protector mount 13 with a plurality of the screws 55.

Note that in the present embodiment, the fixing method with the screw 55 has been described as the method for fixing the protector 5 to the protector mount 13, but is not limited to this configuration. For example, the method for fixing the protector 5 to the protector mount 13 may be welding, swaging, press fitting, bonding, or the like.

The protector 5 constituting the enclosure has at least either one or more recesses or one or more protrusions formed on the opening side. In the present embodiment, notches 57 as recesses are formed at three locations on the opening end side (the unfixed side) of the protector 5 (specifically, in the side surface portion 56 of the protector 5).

Although the provided positions, size, number, and the like of the notches 57 as recesses are not particularly limited, but in the case where the plurality of notches 57 are formed, the notches 57 are preferably arranged at substantially equal intervals along the outer periphery of the opening side of the protector 5 (in the side surface portion 56 of the protector 5).

The operation receiver 6 has the shaft 61 and the operation head 62. Note that the shaft 61 and the operation head 62 may be integral or separate members.

The shaft 61 has one end side inserted through the insertion hole extending through the case 1 from the inside to the outside (in the present embodiment, the through-hole formed by the first insertion hole 14 and the second insertion hole 52) and is arranged at least partially in the case 1 so as to allow switching.

Specifically, as illustrated in FIG. 2, the leading end 611 on the inserted side of the shaft 61 can make contact with the switching plate spring 32 provided for the module 3 in the case 1. When the leading end 611 of the shaft 61 presses the switching plate spring 32 to make contact with the switching electrode 31 directly or indirectly, an operation performed on the switching device 50 is detected, and switching is performed.

Waterproof rings 63 are provided on the outer circumferential surface of the shaft 61. FIG. 2 and the like illustrate a case in which the two waterproof rings 63 are attached to the shaft 61. Note that the number, shape, arrangement, and the like of the waterproof rings 63 are not limited to those in the illustrated example.

These waterproof rings 63 have respective outer circumferential surfaces being in pressing contact with an inner circumferential surface of the through-hole (the through-hole formed by the first insertion hole 14 formed in the protector mount 13 and the second insertion hole 52 formed in the protector 5) and slide in the through-hole in accordance with an operation on the operation receiver 6. This achieves protection against water between the shaft 61 and the through-hole (the through-hole formed by the first insertion hole 14 and the second insertion hole 52).

A groove 612 is formed around the shaft between the leading end 611 of the shaft 61 and the portion in which the waterproof rings 63 are provided. When the shaft 61 is inserted through the through-hole (the through-hole formed by the first insertion hole 14 and the second insertion hole 52), at least the leading end side relative to the groove 612 is arranged in a manner protruding into the case 1. A slip stop member 64 is attached to the groove 612. The shape and the like of the slip stop member 64 are not limited to those in the illustrated example, and an E-ring or the like, for example, is applied as the slip stop member 64 to be fitted within the groove 612.

The slip stop member 64 fitted within the groove 612 abuts on the inner circumferential surface of the case 1 so as to be separated therefrom. When the slip stop member 64 abuts on the inner circumferential surface of the case 1, the shaft 61 of the operation receiver 6 prevents the portion on the leading end side relative to the groove 612 to which the slip stop member 64 is attached from slipping out of the case 1.

The operation head 62 is provided on the other end side of the shaft 61.

The operation head 62 is a portion to be operated by a user with a finger and is formed in a substantially disc-like shape having a diameter larger than the outer diameter of the shaft 61 and smaller than the inner diameter of the side surface portion 56 of the protector 5. The operation head 62 is not particularly limited in shape and the like and is preferably formed in such a size and shape that facilitate operation with a finger or the like. The operation head 62 is arranged at least partially in the protector 5 which is the enclosure when the shaft 61 is inserted into the case 1.

A coil spring 65 is provided around the shaft 61 between the operation head 62 and the portion in which the waterproof rings 63 are provided. The coil spring 65 is a biasing member that biases the operation receiver 6 (the operation head 62 of the operation receiver 6) in a direction away from the case 1. In other words, the coil spring 65 is formed to have a diameter larger than the inner diameter of the second insertion hole 52 (in the present embodiment, the small-diameter cylindrical portion 53 formed in the periphery of the second insertion hole 52) and cannot pass through the second insertion hole 52 (the small-diameter cylindrical portion 53). Thus, one end of the coil spring 65 abuts on the outside of the second insertion hole 52 (in the present embodiment, an upper end surface of the small-diameter cylindrical portion 53), and the other end of the coil spring 65 is brought into a state being in contact with an inner surface of the operation head 62 to bias the operation head 62 in a direction to be pushed out of the case 1. Note that the leading end side of the shaft 61 is caught on the inner circumferential surface of the case 1 by the slip stop member 64 as described earlier. Thus, even if the coil spring 65 biases the operation head 62 toward the outside, the operation receiver 6 does not protrude to such a degree that the operation head 62 projects to the outside of the protector 5, and the state in which the operation head 62 is arranged in the protector 5 is maintained.

Note that since the module 3 has the switching plate spring 32, the coil spring 65 may not be provided.

Protrusions 621 to be fitted within the notches 57 which are recesses on the side of the protector 5 which is the enclosure are formed in a peripheral portion (such as the outer circumferential surface) of the operation head 62 of the operation receiver 6.

The specific shape and the like of the protrusions 621 are not limited, and protrusions having a size and shape corresponding to those of the notches 57 are provided as the protrusions 621 at positions corresponding to the notches 57. In the present embodiment, the protrusions 621 having a claw shape formed to project from an outer end surface 622 of the operation head 62 to the outside of the operation head 62 are formed at three locations at substantially equal intervals along the outer periphery so as to correspond to the positions of the notches 57.

The filter 7 is arranged in the protector 5 which is the enclosure and is formed of an elastic porous material, for example.

A sponge-like elastic porous material, obtained by forming many air bubbles in an elastic material such as a urethane foam, a silicone foam, or an elastomer, for example, is suitably used as the material that forms the filter 7.

The filter 7 is arranged to be interposed between a surface on the farther side (the fixed-side surface 51) of the protector 5 and the operation head 62 and is deformed to contract as appropriate in accordance with an operation on the operation receiver 6.

Specifically, the filter 7 of the present embodiment is formed in a doughnut shape having a through-hole 71 concentrically with the insertion hole (the first insertion hole 14 and the second insertion hole 52).

The filter 7 is placed to surround the insertion hole (in the present embodiment, the second insertion hole 52 in the protector 5) by arranging the small-diameter cylindrical portion 53 of the protector 5 in the through-hole 71.

### Action

When the switching device 50 of the present embodiment is assembled, the protector 5 which is the enclosure of the switching device 50 is first threadably fixed to the protector mount 13 of the case 1 with the screw 55.

Then, the filter 7 is arranged in the protector 5 with the small-diameter cylindrical portion 53 aligned to fall within the through-hole 71.

Furthermore, upon attaching the waterproof rings 63 and the coil spring 65 to the shaft 61, the shaft 61 is inserted through the insertion hole (the first insertion hole 14 and the second insertion hole 52) to attach the operation receiver 6 to the protector 5. At this time, an orientation of inserting the operation receiver 6 is adjusted in such a manner that the respective protrusions 621 of the operation head 62 are fitted within the respective notches 57 of the protector 5.

When the leading end side of the shaft 61 is arranged in the case 1, the slip stop member 64 is attached to the groove 612 in the case 1.

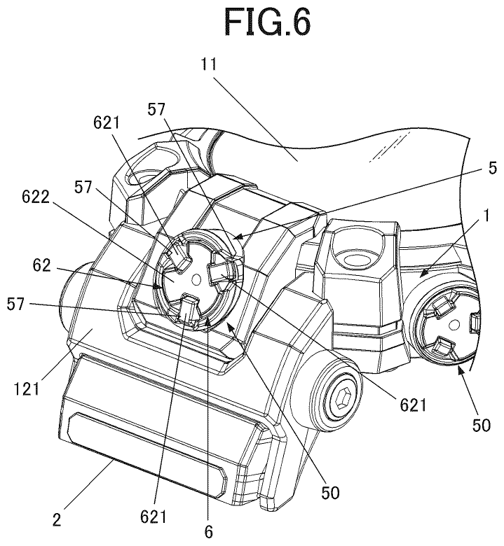

Assembling of the switching device 50 is thereby completed, and a state in which the switching device 50 is incorporated in the timepiece 100 (the state illustrated in FIG. 6) is brought about.

The switching device 50 arranged on the six o'clock side of the timepiece 100 in the present embodiment is a push-button switch for turning a light of the timepiece 100 on/off, for example.

In a case where a user wishes to operate the switching device 50 to perform switching (in the above-described example, in a case where the user wishes to switch between on and off of the light), he/she performs a pressing operation of pushing the operation head 62 of the operation receiver 6 with a finger or the like.

When the operation receiver 6 of the switching device 50 is operated (pressed), the leading end 611 of the shaft 61 of the operation receiver 6 pushes the switching plate spring 32 toward the center of the module 3 against a biasing force of the switching plate spring 32. When the switching plate spring 32 makes contact with the switching electrode 31 directly or indirectly through the pressing operation on the operation receiver 6 and is brought into a conducting state, the operation performed on the switching device 50 is detected by LSI or the like, and switching is performed. In other words, in the above-described example, an operation in accordance with the function of the switching device 50, such as switching between on and off of the light, is performed.

When the pressing operation on the operation receiver 6 is performed, the operation head 62 slides in the protector 5 in the direction along the shaft. The protrusions 621 provided for the operation head 62 slide accordingly in the notches 57 formed in the protector 5 in the direction along the shaft. In other words, when the operation receiver 6 is pushed, the protrusions 621 are sunk farther into the notches 57, and when the pressing operation made by the user is stopped, the protrusions 621 are pushed out of the case 1 by the spring force of the switching plate spring 32 and the biasing force of the coil spring 65.

The protector 5 does not rotate around the shaft because of being threadably fixed to the case 1. Thus, rotation of the operation receiver 6 around the shaft with the protrusions 621 fitted within the notches 57 is also restricted, so that the outer end surface 622 of the operation head 62 keeps the same orientation all the time.

Even when the operation receiver 6 is pushed outward by the spring force of the switching plate spring 32 and the biasing force of the coil spring 65, the slip stop member 64 will not protrude to the outer side relative to the position at which the slip stop member 64 abuts on the inner circumferential surface of the case 1. Thus, the state in which the operation head 62 is arranged in the protector 5 is held.

The protector 5 and the operation head 62 of the operation receiver 6 are exposed to the outside of the case 1. Thus, foreign matters such as dirt and dust may enter the switching device 50 through places such as the gap between the protector 5 and the operation head 62 of the operation receiver 6.

In this respect, the filter 7 formed of an elastic porous material is provided in the protector 5 of the switching device 50 of the present embodiment. Thus, even if foreign matters such as dirt enter the switching device 50, large-particle foreign matters are blocked by the filter 7, and fine-particle foreign matters are absorbed into air bubbles of the sponge-like filter 7. Therefore, foreign matters such as dirt cannot enter the insertion hole (the first insertion hole 14 and the second insertion hole 52) irrespective of the size of particles.

When the pressing operation on the operation receiver 6 is made by the user, the filter 7 is deformed to contract as appropriate between the fixed-side surface 51 of the protector 5 and the operation head 62 of the operation receiver 6. In more detail, the filter 7 is structured to be deformed when pressed in such a manner that many air bubbles provided in the sponge-like elastic porous material are broken. Such deformation that many air bubbles are broken causes small-particle foreign matters such as dirt, dust, and sand having entered the air bubbles to be discharged from within the air bubbles, thereby preventing the air bubbles from being blocked with the foreign matters.

When the pressing operation made by the user is stopped, the shaft 61 is pressed (pushed back) by the spring force of the switching plate spring 32 to slide toward the outside of the case 1, and the operation head 62 returns to an initial position prior to the pressing operation made by the user. At that time, the filter 7 is restored slowly to an original shape following, or with a slight delay from, the returning motion of the operation head 62. When the filter 7 is restored slowly to the original shape, many air bubbles in the sponge-like filter 7 are also deformed to expand to an original shape in a manner expanding slowly. Note that when the air bubbles are deformed to expand to the original shape in a manner expanding slowly, large-particle foreign matters among foreign matters such as dirt and sand having entered the switching device 50 through places such as the gap between the protector 5 and the operation head 62 of the operation receiver 6 are not captured into the air bubbles and are blocked from entering the air bubbles even if small-particle foreign matters may slowly enter the air bubbles.

### Effects

As described above, the switching device 50 in the present embodiment includes: the protector 5 which is the enclosure that is provided on the outer part of the case 1 and opens toward the outside of the case 1; the filter 7 arranged in the enclosure; the operation receiver 6 that is arranged on the outer side of the case 1 relative to the filter 7 and includes the shaft 61 having one end side inserted in the insertion hole (the first insertion hole 14 and the second insertion hole 52) provided to extend through from the enclosure toward the inside of the case 1 and the operation head 62 provided on the other end side of this shaft 61 and arranged at least partially in the enclosure; and the rotation restrictor that restricts rotation of the operation receiver 6.

More specifically, the switching device 50 includes the protector 5 which is the enclosure that is provided on the outer part of the case 1 and opens toward the outside of the case 1, the operation receiver 6 having the shaft 61 having one end side inserted in the insertion hole (the first insertion hole 14 and the second insertion hole 52) provided to extend through from the fixed-side surface 51 of the protector 5 which is the surface on the farther side of the enclosure toward the inside of the case 1 and arranged in the case 1 so as to allow switching and the operation head 62 provided on the other end side of the shaft 61 and arranged at least partially in the protector 5 which is the enclosure, and the filter 7 arranged in the protector 5 which is the enclosure to be interposed between the fixed-side surface 51 (the surface on the farther side) and the operation head 62 and deformed to contract in accordance with an operation on the operation receiver 6. The notches 57 as recesses are formed at three locations on the opening side of the protector 5 which is the enclosure. The protrusions 621 to be fitted within the notches 57 are formed on the operation head 62 of the operation receiver 6. The configuration in which the notches 57 and the protrusions 621 are fitted with each other functions as the rotation restrictor.

In the case where the protector 5 and the operation head 62 of the operation receiver 6 are exposed to the outside of the case 1, foreign matters such as dirt, dust, and sand might enter through the gap and the like.

In this respect, in the present embodiment, the switching device 50 includes the filter 7 therein. Thus, even if dirt and the like enter the switching device 50 through the gap or the like, foreign matters such as dirt can be prevented from entering the insertion hole (the first insertion hole 14 and the second insertion hole 52). Accordingly, long-term use does not cause degradation in operability, such as difficulty in pushing the operation receiver 6 of the switching device 50, or poor protection against water, and the switching device 50 can be used continuously in a favorable state.

Even in the case where this configuration of preventing entry of foreign matters is adopted, the rotation restrictor is configured by fitting the protrusions 621 within the notches 57 as recesses to cause the operation receiver 6 to be caught on the protector 5, so that rotation of the operation receiver 6 around the shaft can be restricted without increasing the switching device 50 in size or complicating its structure. The outer end surface 622 (a button top) of the operation head 62 of the operation receiver 6 is a portion that appears in the appearance of the timepiece 100 or the like, and a decoration such as a logo or a pattern may be added to the outer end surface 622 or the like of the operation head 62, for example. Even in such a case, the orientation of the operation head 62 can be maintained at the same orientation all the time by adopting the configuration of the present embodiment, thus achieving excellent design.

In the present embodiment, the switching device 50 includes the cylindrical protector 5 fixed to the case 1 with the first insertion hole 14 formed to extend through from the inside to the outside, having in the fixed-side surface 51 the second insertion hole 52 corresponding to the first insertion hole 14, and having the open, unfixed side, and the enclosure is implemented by the protector 5.

Since the enclosure is implemented by the protector 5 which is separate from the case 1, the case 1 and the switching device 50 are easy to manufacture, and flexibility in design and the like is improved.

In the present embodiment, the notches 57 which are recesses on the side of the protector 5 which is the enclosure are formed at three locations at equal intervals along the outer periphery on the opening side of the protector 5, and the protrusions 621 corresponding to the notches 57 which are recesses on the protector 5 side are formed at three locations on the periphery of the operation head 62 of the operation receiver 6.

The operation receiver 6 can thereby be caught on the protector 5 at a plurality of locations around the shaft. This can prevent improper rotation of the operation receiver 6 more reliably.

When the plurality of notches 57 and the protrusions 621 to be fitted within the notches 57 are arranged at substantially equal intervals along the outer periphery, backlash or rattling of the operation receiver 6 in the protector 5 can be prevented, which can restrict rotation more stably.

The filter 7 of the present embodiment is formed of an elastic porous material.

The filter 7 is thus deformed to contract as appropriate when the pressing operation on the operation receiver 6 is performed. At that time, the filter 7 is deformed in such a manner that air bubbles are broken, causing small-particle foreign matters such as dirt, dust, and sand having entered the air bubbles to be discharged from within the air bubbles, which can prevent the air bubbles from being blocked with the foreign matters.

The filter 7 of the present embodiment is formed in a doughnut shape so as to surround the insertion hole (the second insertion hole 52) concentrically with the insertion hole (the first insertion hole 14 and the second insertion hole 52).

This can prevent the filter 7 from being displaced in the protector 5 and can block foreign matters such as dirt having entered the switching device 50 from even entering the insertion hole (the first insertion hole 14 and the second insertion hole 52).

In the case where the timepiece 100 includes the switching device 50 as described above, foreign matters such as dirt can be prevented from entering the portion of the switching device 50 which is the push-button switch or the like, which enables operability and waterproof performance of the switching device 50 to be maintained in a favorable state even if the timepiece 100 is used for a long time.

Even in the case where the configuration of preventing entry of foreign matters is adopted, the operation receiver 6 is caught on the protector 5 by fitting the protrusions 621 within the notches 57 which are recesses, so that rotation around the shaft can be restricted. Thus, also in the case where a decoration such as a logo or a pattern is added to the outer end surface 622 or the like of the operation head 62, for example, the same orientation can be maintained all the time, and an appearance with excellent design can be achieved.

### Variations

Note that although an embodiment of the present disclosure has been described above, it goes without saying that the present disclosure is not limited to such an embodiment and can be variously modified within a range not departing from the spirit of the invention.

For example, the present embodiment has illustrated the case in which the notches 57 which are recesses are provided at three locations on the protector 5 side, and the protrusions 621 corresponding to the notches 57 are provided at three locations on the operation receiver 6 side, but the switching device 50 is not limited to the configuration described in the embodiment as long as either one or more recesses or one or more protrusions are formed on the protector 5 which is the enclosure, and either protrusions or recesses to be fitted within or over the recesses or protrusions on the side of the protector 5 which is the enclosure are formed on the operation head 62 of the operation receiver 6.

For example, a protrusion protruding inward may be provided on the protector 5 side, and a recess such as a notch to be fitted over this protrusion may be formed in the outer periphery of the operation head 62 of the operation receiver 6.

If a set of the recess and the protrusion on the protector 5 side and the operation receiver 6 side is provided even at one location, rotation around the shaft can be restricted. Thus, the present disclosure is not limited to the case in which three sets of the recess and the protrusion are provided respectively at three locations in the switching device 50 as in the present embodiment, and more or less sets may be provided.

For example, in the present embodiment, the case in which the enclosure of the switching device 50 is implemented by the protector 5 which is the member separate from the case 1 and is mounted on the protector mount 13 of the case 1 has been described, but the enclosure is not limited to this configuration.

For example, the enclosure constituting the switching device 50 may be formed integrally with the case 1.

In this case, the number of components can be reduced, and the structure can be simplified.

The present embodiment has illustrated the case in which the protrusions on the operation receiver 6 side are the claw-like protrusions 621 formed to project from the outer end surface 622 of the operation head 62 to the outside of the operation head 62, but the provided place, shape, and the like of the protrusions are not limited to them.

The protrusions on the operation receiver 6 side should only correspond to the recesses formed on the protector 5 side, and protrusions may be formed on the outside surface of the operation head 62 (such as the circumferential surface of the operation head 62) or the like, for example.

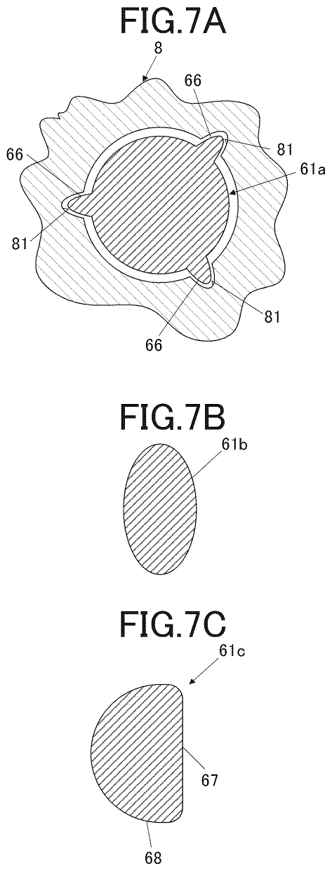

As illustrated in FIG. 7A, the rotation restrictor may have the following configuration. In other words, either first recesses or first protrusions may be formed on the circumferential surface of the shaft 61 (in FIG. 7A, a shaft 61a), and second protrusions to be fitted within the first recesses or second recesses to be fitted over the first protrusions may be formed on a member (referred to as a “member 8” in FIG. 7A) that is positioned on the outer peripheral side of the shaft 61a and receives the shaft 61a. In this case, a single first recess or a single first protrusion may be provided, or a plurality of first recesses or a plurality of first protrusions may be provided. It is desirable that the number of the second protrusions or second recesses should be the same as the number of the first recesses or first protrusions.

Note that FIG. 7A illustrates the case in which three first protrusions 66 are formed on the circumferential surface of the shaft 61a, and three second recesses 81 to be fitted over the first protrusions 66 are formed in the member 8 that receives the shaft 61a, which function as the rotation restrictor.

Alternatively, as illustrated in FIG. 7B, a shaft 61b as the rotation restrictor may be oval or the like rather than being a true circle. Alternatively, a shaft 61c may have a shape having a planar portion 67 and a curved portion 68 as illustrated in FIG. 7C to function as the rotation restrictor.

The above embodiment has illustrated and described the case in which an electronic device provided with the switching device 50 is the wristwatch-type timepiece 100, but the an electronic device provided with the switching device 50 is not limited to a wristwatch-type timepiece.

For example, the switching device 50 of the present embodiment may be applied to a portable timepiece or the like not to be worn on the arm.

Examples of the electronic device to which the switching device 50 is applied may widely include wrist devices such as smartwatches to be worn or carried by a user, activity measuring instruments, vital measuring instruments, and the like.

In a case where the electronic device is something other than a timepiece, the module 3 (timepiece module) does not need to be provided, and components and the like necessary for achieving the function of each piece of electronic device are mounted in the case 1.

Though several embodiments of the present disclosure have been described above, the scope of the present disclosure is not limited to the above-mentioned embodiments. Specific configurations, structures, positional relationships, and the like shown in the above embodiments can be changed as appropriate in the range not departing from the gist of the present disclosure. The scope of the present disclosure includes the scope of inventions, which is described in the scope of claims, and the scope equivalent thereof.

1. A switching device comprising:
an enclosure that is provided on an outer part of a case and opens toward an outside of the case;
a filter arranged in the enclosure;
an operation receiver that is arranged on an outer side of the case relative to the filter and includes:
a shaft having one end side inserted in an insertion hole provided to extend through from the enclosure toward an inside of the case; and
an operation head provided on the other end side of the shaft and arranged at least partially in the enclosure; and
a rotation restrictor that restricts rotation of the operation receiver.

2. The switching device according to claim 1, wherein a first recess or a first protrusion as the rotation restrictor is formed on an opening side of the enclosure.

3. The switching device according to claim 2, wherein a second protrusion or a second recess fitted within or over the first recess or the first protrusion of the enclosure is formed on the operation head of the operation receiver.

4. The switching device according to claim 3, wherein the shaft of the operation receiver is arranged in the case so as to allow switching.

5. The switching device according to claim 4, wherein the filter is deformed to contract in accordance with an operation on the operation receiver.

6. The switching device according to claim 3, wherein the enclosure is a cylindrical protector that is fixed to the case with a first insertion hole formed to extend through from inside to outside, has a second insertion hole corresponding to the first insertion hole in a fixed-side surface, and is open on an unfixed side.

7. The switching device according to claim 4, wherein the enclosure is a cylindrical protector that is fixed to the case with a first insertion hole formed to extend through from inside to outside, has a second insertion hole corresponding to the first insertion hole in a fixed-side surface, and is open on an unfixed side.

8. The switching device according to claim 3, wherein the first recess or the first protrusion of the enclosure is formed at three locations at equal intervals along an outer periphery of the enclosure on an opening side.

9. The switching device according to claim 8, wherein the second protrusion or the second recess corresponding to the first recess or the first protrusion of the enclosure is formed at three locations on a periphery of the operation head of the operation receiver.

10. The switching device according to claim 1, wherein the filter is formed of an elastic porous material.

11. The switching device according to claim 2, wherein the filter is formed of an elastic porous material.

12. The switching device according to claim 3, wherein the filter is formed of an elastic porous material.

13. The switching device according to claim 4, wherein the filter is formed of an elastic porous material.

14. The switching device according to claim 5, wherein the filter is formed of an elastic porous material.

15. The switching device according to claim 1, wherein the filter is formed in a doughnut shape so as to surround the insertion hole concentrically with the insertion hole.

16. The switching device according to claim 2, wherein the filter is formed in a doughnut shape so as to surround the insertion hole concentrically with the insertion hole.

17. The switching device according to claim 3, wherein the filter is formed in a doughnut shape so as to surround the insertion hole concentrically with the insertion hole.

18. The switching device according to claim 6, further comprising a biasing member that is provided on an outer periphery of the shaft and formed to have a diameter larger than an inner diameter of the second insertion hole.

19. An electronic device comprising:
the switching device according to claim 1; and
the case.

20. A timepiece comprising:
the switching device according to claim 1;
the case; and
a timepiece module enclosed in the case.
